(19) United States
(12) Patent Application Publication
(10) Pub. No.: US 2024/0270914 A1
(43) Pub. Date: Aug. 15, 2024

(54) OMNIDIRECTIONALLY STRETCHABLE FIBER-REINFORCED COMPOSITE FILM AND MANUFACTURING METHOD THEREOF

(71) Applicant: KOREA ADVANCED INSTITUTE OF SCIENCE AND TECHNOLOGY, Daejeon (KR)

(72) Inventors: Byeong-Soo BAE, Daejeon (KR); Yung LEE, Daejeon (KR)

(21) Appl. No.: 18/568,984

(22) PCT Filed: Oct. 12, 2022
(86) PCT No.: PCT/KR2022/015399

§ 371 Date: Dec. 11, 2023

(30) Foreign Application Priority Data
Jan. 11, 2022 (KR) 10-2022-0003941

(51) Int. Cl. C08J 5/24; B29C 70/12; B29C 70/54; B29K 83/00; B29K 277/00; B29K 309/08

(52) U.S. Cl. CPC C08J 5/244; B29C 70/12; B29C 70/545; C08J 5/246; B29K 2083/00; B29K 2277/10; B29K 2309/08; B29K 2995/0046; B29K 2995/0077; C08J 2383/04

(57) ABSTRACT

The present invention provides a fiber-reinforced composite film with omnidirectional stretchability on which an auxetic structure 100 is formed integrally with the film on a film, wherein the auxetic structure 100 comprises a plurality of space regions 130 in the form of single closed curves regularly arranged on the film; an island 120 formed surrounded by the space region 130; and a connection portion 110 formed at regular intervals by the space region 130 to connect adjacent islands 120; wherein the film, island 120 and connection portion 110 are plastic materials reinforced with fibers wherein the space region 130 is filled with the elastic auxiliary member 20 and a manufacturing method thereof.

### CROSS-REFERENCE TO RELATED APPLICATION

This application claims priority to and the benefit of Korean Patent Application No. 10-2022-0003941 filed in the Korean Intellectual Property Office on Jan. 11, 2022, the entire contents of which are incorporated herein by reference.

### BACKGROUND OF THE INVENTION

### (a) Field of the Invention

The present invention relates to a fiber-reinforced composite film with omnidirectional stretchability and a manufacturing method thereof, and more specifically, relates to a fiber-reinforced composite film having omnidirectional stretchability by using a fiber-reinforced plastic as a material of the film on which the auxetic structure is formed, and a manufacturing method thereof.

### (b) Description of the Related Art

Recently, displays and electronic devices with flexible form factors such as foldable, rollable, and stretchable devices are highlighted as the market demands and technology development. In particular, the versatile deformability of stretchable displays offers design freedom, broadening their applications in portable electronics, the Internet of Things (IoT), and home appliances.

Components of a stretchable device are classified to a driving element, an electrode, and a substrate. Especially, the driving element in the conventional displays and electronic devices, which is a key component of electronic devices, is vulnerable to deformation. Hence, it has traditionally been manufactured on rigid substrates such as glass, silicon wafers, metal foils, or fiber reinforced plastic (FRP), which provides a flat surface while minimizing deformation.

However, in order to realize stretchable displays and electronic devices, the base substrate must be flexible and stretchable, and driving elements and electrodes must also have flexibility and stretchability. Therefore, in general, a method of implementing a stretchable device using an elastomer having high elasticity as a substrate has been used. However, stretchable driving elements and electrodes for stretchable displays formed on an elastomeric substrate show lower driving performance, higher resistance, and performance change when stretched than conventional elements and electrodes that are vulnerable to deformation. Therefore, in order to maximize the performance of the stretchable display, it is essential to provide a stretchable substrate capable of using conventional high-performance devices and electrodes that are vulnerable to conventional deformation. Even though there have been studies on substrates composed of deformable and a rigid parts to make stretchable devices using high-performance elements and electrodes that are vulnerable to deformation, such structures have interfacial bonding problems due to the difference in physical properties of heterogeneous materials that are composed of the deformable and rigid parts, and there is a problem that the aspect ratio of the substrate severely changes during stretching due to the high positive Poisson's ratio value of the deformable part.

Therefore, in order to exhibit omnidirectional stretchability, contraction in other directions should be minimized during stretching of the material, and therefore, a material exhibiting a low or negative Poisson's ratio value is required. A typical method for realizing a low or negative Poisson's ratio is to form an auxetic structure. However, since the auxetic structure may contain empty spaces in its structure, it may provide limited processability as a substrate material. In addition, since a typical plastic material used as a substrate does not have sufficient tensile strength or has a low elastic modulus, there is a limit to lowering the Poisson's ratio by compositing with a stretchable material even when an auxetic structure is formed. In addition, there is a problem in that interfacial separation may occur during stretching due to low bonding with the stretchable material.

The above information disclosed in this Background section is only for enhancement of understanding of the background of the invention, and therefore it may contain information that does not form the prior art that is already known in this country to a person of ordinary skill in the art.

### SUMMARY OF THE INVENTION

An object of the present invention is to provide a fiber-reinforced composite film having omnidirectional stretchability that minimizes shape distortion during stretching due to positive Poisson's ratio value, and facilitates regular deformation in all directions, and manufacturing method thereof, in order to solve the problems by using fiber-reinforced plastics as the material for the film in which the auxetic structure is formed.

According to an embodiment of the present invention, a fiber-reinforced composite film having omnidirectional stretchability on which an auxetic structure 100 may be formed integrally with the film on a film, wherein the auxetic structure 100 may comprises a plurality of space regions 130 in the form of single closed curves regularly arranged on the film; an island 120 formed surrounded by the space region 130; and a connection portion 110 formed at regular intervals by the space region 130 to connect adjacent islands 120; wherein the film, island 120 and connection portion 110 may be fiber-reinforced plastic materials, wherein the space region 130 may be an empty space or filled with the elastic auxiliary member 20.

The composition of the fiber 12 may be one or more selected from the group consisting of glass, silica, quartz, carbon, and aramid.

The plastic may be one or more selected from the group consisting of synthetic resin, synthetic rubber, natural resin, and natural rubber; which is any one of thermosetting, thermoplastic, photo polymerizing, and room temperature vulcanizing.

The elastic modulus of the fiber-reinforced plastic material may be 500 times or more of the elastic modulus of the elastic auxiliary member 20.

The elastic auxiliary member 20 may be one or more selected from the group consisting of synthetic resin, synthetic rubber, natural resin, and natural rubber; which is any one of thermosetting, thermoplastic, photo polymerizing, and room temperature vulcanizing.

The fiber-reinforced composite film with omnidirectional stretchability according to an embodiment of the present invention may have a negative Poisson's ratio value.

According to an embodiment of the present invention, a method for manufacturing a fiber-reinforced composite film with omnidirectional stretchability, may comprise: manufacturing a fiber-reinforced plastic film; and forming an auxetic structure 100 by forming a space region 130 on the film.

According to an embodiment of the present invention, a method for manufacturing a fiber-reinforced composite film with omnidirectional stretchability, may further comprise filling the space region 130 with an elastic auxiliary member 20.

The composition of the fiber 12 may be one or more selected from the group consisting of glass, silica, quartz, carbon, and aramid.

The step of manufacturing a fiber-reinforced plastic film; may comprise manufacturing a fiber-plastic matrix mixture 14 by compositing the fibers 12 and the plastic matrix material 13; forming the fiber-plastic matrix mixture 14 into a film form; and curing the mixture molded into the film form to manufacture a fiber-reinforced composite film 15.

The fiber 12 may be one or more types selected from the group consisting of particles, yarns, strands and fabrics.

The step of manufacturing a fiber-reinforced composite film 15 by curing the mixture molded into a film form; may be performed by one or more methods selected from the group consisting of thermal curing, photo-polymerization, and room temperature vulcanization.

The step of forming an auxetic structure 100 by forming a space region 130 on the film; may be performed by one or more methods selected from the group consisting of laser cutting, press punch, CNC (computer numerical control) machining, molding, printing, and photolithography.

The step of filling the space region 130 with the elastic auxiliary member 20; may be performed by one or more methods selected from the group consisting of screen printing, ink-jet printing, bar coating, spin coating, impregnation, hand layup, autoclave and resin infusion.

According to an embodiment of the present invention, a stretchable device may include the above-described fiber-reinforced composite film or a fiber-reinforced composite film manufactured by the above-described manufacturing method.

According to an embodiment of the present invention, the fiber-reinforced composite film may have omnidirectional stretchability, and shape distortion due to the Poisson effect during stretching may be controlled. In addition, regions of the deformable and the rigid portions are divided to provide a substrate suitable for an electronic device vulnerable to deformation.

### BRIEF DESCRIPTION OF THE DRAWINGS

FIG. 1 is a schematic plan view of a fiber-reinforced composite film 1 with omnidirectional stretchability according to an embodiment of the present invention.

FIG. 2 is an enlarged plan view of a part of the auxetic structure 100 of the fiber-reinforced composite film 1 with omnidirectional stretchability according to an embodiment of the present invention, showing the behavior occurring in the unit structure of the pattern when the film is stretched.

FIG. 3 is a plan view showing an example of various types of space regions 130.

FIG. 4 is a plan view showing an example of an arrangement of space regions 130 in a non-orthogonal coordinate system exhibiting omnidirectional stretch characteristics.

FIG. 5 is a flowchart showing a method of manufacturing a fiber-reinforced composite film 1 with omnidirectional stretchability according to an embodiment of the present invention.

FIG. 6 is a schematic diagram showing a step of manufacturing a fiber-reinforced composite film 15 in a method for manufacturing a fiber-reinforced composite film 1 with omnidirectional stretchability according to an embodiment of the present invention.

FIG. 7 is a schematic diagram showing of process of forming the space region 130 by cutting the fiber-reinforced composite film 15 with laser cutter 4 and then filling the elastic auxiliary member 20 in the space region 130 by the roll lamination method, in an embodiment of the present invention.

FIG. 8 shows (a) ink-jet printing (b) moulding (c) photolithography method among various methods that can be used when forming a space region 130 in a fiber-reinforced composite film 15 in a method for manufacturing a fiber-reinforced composite film 1 with omnidirectional stretchability according to an embodiment of the present invention.

FIG. 9 is an image showing a change in shape of a fiber-reinforced composite film 1 with omnidirectional stretchability when it is stretched or contracted, according to an embodiment.

FIG. 10 is a graph showing the Poisson's ratio that changes as the fiber-reinforced composite films manufactured according to Examples 1 and 2 of the present invention are stretched.

FIG. 11 is a graph showing the Poisson's ratio that changes as the fiber-reinforced composite films manufactured according to Examples 3 and 4 of the present invention are stretched.

FIG. 12 is a graph showing the Poisson's ratio that changes as the films manufactured according to Comparative Example 1, Comparative Example 2, and Comparative Example 3 of the present invention are stretched.

FIG. 13 is a strain distribution measurement image showing the change in elongation rate within the film during stretching of the fiber-reinforced composite film manufactured according to Example 3 of the present invention.

FIG. 14 is a strain distribution measurement image showing the change in elongation rate within the film manufactured according to Comparative Example 1 of the present invention when it is stretched or contracted.

### DETAILED DESCRIPTION OF THE EMBODIMENTS

Terms such as first, second and third are used to describe, but are not limited to, various parts, components, regions, layers and/or sections. These terms are only used to distinguish one part, component, region, layer or section from another part, component, region, layer or section. Accordingly, a first part, component, region, layer or section described below may be referred to as a second part, component, region, layer or section without departing from the scope of the present invention.

The terminology used herein is only for referring to specific embodiments and is not intended to limit the present invention. As used herein, the singular forms also include the plural forms unless the phrases clearly indicate the opposite. The meaning of “comprising” as used herein specifies particular characteristic, region, integer, step, operation, element and/or component, and does not exclude the presence or addition of other characteristic, region, integer, step, operation, element and/or component.

When a part is referred to as being “on” or “above” another part, it may be directly on or on the other part or may be followed by another part therebetween. In contrast, when a part is said to be “directly on” another part, there is no intervening part between them.

Poisson's ratio is a numerical value representing the behavior according to the stretching of the material, and means the amount of length decrease in the direction perpendicular to the stretching compared to the length increase in the stretching direction when the material is stretched. Contraction in a direction perpendicular to the elongation direction not only significantly changes the shape of the material during stretching, but also increases the rigidity of the material when forces are applied in multiple directions of two or more axes, making it difficult to deform. In general, materials tend to resist volume change and thus have a positive Poisson's ratio.

The auxetic structure collectively refers to a structure exhibiting a negative Poisson's ratio value, and minimizes deformation of the structural material during expansion and contraction through the expansion of a cutout and exhibits a negative Poisson's ratio value.

Unless otherwise indicated, % means weight %, and 1 ppm is 0.0001 weight %.

The drawings referred to describe the embodiments of the present invention may be intentionally exaggerated in size, height, thickness, etc. for convenience of description and ease of understanding, and are not enlarged or reduced in absolute proportion. In addition, any one component shown in the drawings may be intentionally reduced and expressed, and other components may be intentionally enlarged and expressed.

In addition, each step in the manufacturing step may occur in a different order from the specified order unless a specific order is clearly described in context. That is, each step may occur in the same order as specified, may be performed substantially simultaneously, or may be performed in the reverse order.

Although not defined differently, all terms including technical terms and scientific terms used herein have the same meaning as commonly understood by those of ordinary skill in the art to which the present invention belongs. Terms defined in commonly used dictionaries are additionally interpreted as having meanings consistent with related technical literature and currently disclosed content, and are not interpreted in ideal or very formal meanings unless defined.

Hereinafter, with reference to the accompanying drawings, embodiments of the present invention will be described in detail so that those skilled in the art can easily carry out the present invention. However, the present invention may be embodied in many different forms and is not limited to the embodiments described herein.

### The Fiber-Reinforced Composite Film

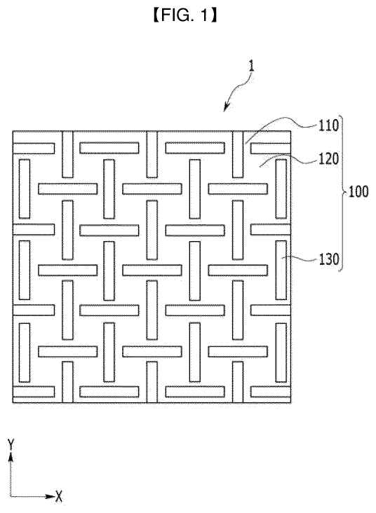

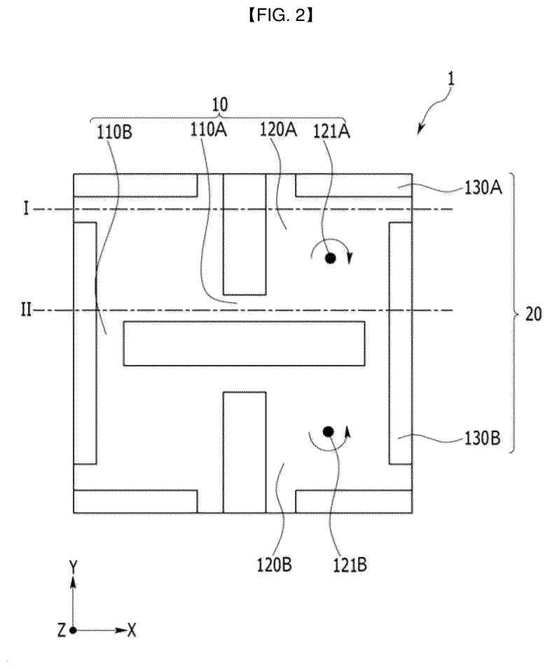

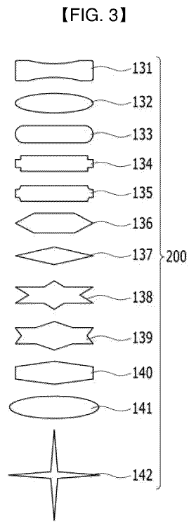

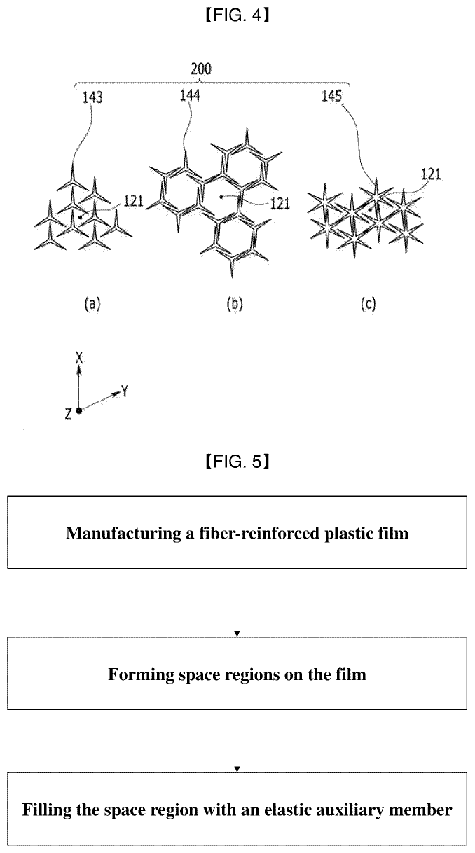

FIG. 1 is a schematic plan view of a fiber-reinforced composite film 1 with omnidirectional stretchability according to an embodiment of the present invention, and FIG. 2 is an enlarged plan view of a part of the auxetic structure 100 of the fiber-reinforced composite film 1 with omnidirectional stretchability according to an embodiment of the present invention, showing the behavior occurring in the unit structure of the pattern when the film is stretched, and FIG. 3 is a plan view showing an example of various types of space region 130, and FIG. 4 is a plan view showing an example of an arrangement of space region 130 in a non-orthogonal coordinate system exhibiting omnidirectional stretch characteristics. Hereinafter, a fiber-reinforced composite film 1 with omnidirectional stretchability according to an embodiment of the present invention will be described in detail with reference to FIG. 1 to FIG. 4.

According to an embodiment of the present invention, a fiber-reinforced composite film having omnidirectional stretchability on which an auxetic structure 100 may be formed integrally with the film on a film, wherein the auxetic structure 100 may comprises a plurality of space regions 130 in the form of single closed curves regularly arranged on the film; an island 120 formed surrounded by the space region 130; and a connection portion 110 formed at regular intervals by the space region 130 to connect adjacent islands 120; wherein the film, island 120 and connection portion 110 may be plastic materials reinforced with fibers.

Fiber-reinforced plastic (FRP) is a composite material manufactured by reinforcing plastic with fibers 12 having high tensile strength and elastic modulus. By using fiber-reinforced plastic as a material for the film, the island 120, and the connection portion 110, the resulting material exhibits both high moldability and compatibility between the plastic and fiber 12, while also providing the required mechanical stiffness and tensile strength of the fiber 12 as a reinforcing member. In addition, since the fiber-reinforced plastic has a high tensile strength that can withstand local stress, which is a characteristic required as a material for the auxetic structure 100, and a wide elastic range for restoring force during expansion and contraction, by using this as a material for the island 120 and the connecting part 110 of the auxetic structure 100, due to the structure in which the island 120 rotates and expands in all directions when the film is stretched, the characteristics of the auxetic structure 100 having a lower Poisson's ratio value than the original Poisson's ratio value of the constituent materials may be complemented, a negative Poisson's ratio value may be obtained.

Describing the driving principle of the auxetic structure 100 in detail, the connection portion 110 is aligned with respect to at least two axes on a plane, but is not arranged in a straight line with the adjacent connection portion 110 on a parallel axis. Therefore, when a tensile force is applied to the film, the connecting portion 110 tends to be arranged in the elongation direction, which applies a shear stress to the island 120 and causes the island 120 to rotate. Accordingly, by rotating the island 120, an expansion occurs in a direction different from the direction in which the tensile force is applied, and a negative Poisson's ratio appears.

Of the auxetic structure 100, the connecting portion 110 and the island 120 may be bonded to each other to be continuous, and may be made of the same material. In addition, the fiber-reinforced plastic material island 120 and the connection portion 110 may be defined as the fiber-reinforced part 10. In order for the fiber-reinforced composite film 1 with omnidirectional stretchability according to an embodiment of the present invention to exhibit omnidirectional stretchability, the high tensile strength of the connection portion 110 in which the fiber-reinforced part 10 accommodates the tension applied to the film, and a high elastic modulus of the connecting portion 110 aligned in a direction perpendicular to the tension and a high stiffness of the island 120 capable of resisting the tension are required. When the fiber-reinforced part 10 is made of a material having low tensile strength, the connection portion 110 may be damaged due to the tension applied to the connection portion 110 during elongation, and thus the stretchability of the film may be decreased. In addition, when the fiber-reinforced part 10 is a material having low stiffness, the island 120 has room to be deformed rather than rotated, and even if rotated, the connecting portion 110 aligned in a direction not parallel to the tension causes deformation, which may greatly reduce stretchability in all directions. In the fiber-reinforced composite film 1 with omnidirectional stretchability according to an embodiment of the present invention, since the fiber-reinforced part 10 is made of fiber-reinforced plastic material and has high tensile strength and stiffness for the above reasons, omnidirectional stretchability is exhibited.

For example, referring to FIG. 2, the connection unit 110 may include a first connection unit 110A aligned in a first direction (x-axis direction) and a second connection unit 110B aligned in a second direction (y-axis direction). In addition, the first connection portion 110A may be aligned along the axes I and II in a first imaginary direction (x-axis direction), and adjacent connecting portions 110 on parallel axes of the same island 120 may be in the same direction and not aligned on the same axis. When the film is stretched in the first direction (x-axis direction), tension is applied to the first connection portion 110A, and adjacent connecting portions 110 are in contact with each other on different axes I and II with respect to the first island 120A, so that shear stress is generated. The first island 120A may rotate along the first virtual rotation axis 121A due to the shear stress generated, and at this time, the rotation direction of the adjacent second island 120B rotating along the second virtual rotation axis 121B may be different from each other. Accordingly, rotation of the island 120 may expand the space region 130 and expand the film in all directions. In addition, due to the structure in which the area of the space region 130 may be reduced and the island 120 rotates even when the film is shrunk, the entire film may exhibit omnidirectional shrinkage characteristics. Accordingly, the fiber-reinforced composite film 1 with omnidirectional stretchability according to an embodiment of the present invention may have a negative Poisson's ratio value through the above-described omnidirectional stretching behavior.

The space region 130 may be formed as a single closed curve, have an effective area, and may be arranged along two or more imaginary axes in different directions, and the connection portion 110 may be formed by forming the space region 130 spaced apart from each other by a predetermined distance.

Referring to FIG. 3, the space region 130 may be a geometric figure composed of a single closed curve, for example, a polygon, a circle, an ellipse, or a mixture and transformation thereof. The shape of the connection portion 110 and the island 120 is determined by forming the space region 130, and the shape of the space region 130 is a structure in which the island 120 may be rotated by the connecting portion 110 receiving tension in the direction of extension when stretched, and if the film may exhibit omnidirectional stretchability, this example is not necessarily limited to the example.

Referring to FIG. 4, the space region 130 may be arranged along each axis even in a non-orthogonal coordinate system in which a first axis (x axis) and a second axis (y axis) form an angle of 60 degrees, and it may be arranged in a vertically inverted form along each axis. This arrangement may form the connecting portion 110 and the island 120 as described above, and each island 120 may rotate around the virtual rotation axis 121 and expand the film when stretched. In addition to the examples shown in FIGS. 3 and 4, as long as the unit structure of the pattern consisting of the connection portion 110 and the island 120 fill the plane, the space regions 130 having two or more different shapes may be mixed, it may be a pattern in which the space regions 130 are aligned along two or more axes in different directions. In addition, the space region 130 may be a pattern arranged along a spherical coordinate system or a curved coordinate system, and may be arranged in three dimensions.

The space region 130 may be an empty space or may be filled with the elastic auxiliary member 20. When the space region 130 is an empty space, the fiber-reinforced composite film with omnidirectional stretchability according to an embodiment of the present invention has an auxetic structure 100, so it may have negative Poisson's ratio value by the tension applied to the connecting portion 110.

When the space region 130 is filled with the elastic auxiliary member 20, a continuous flat surface may be provided to the film, thereby providing structural characteristics suitable as a substrate for a stretchable device. If the film is not provided with such a continuous and flat surface, there are disadvantages in that it is difficult to use some processes such as microprocessing and solution processing as a substrate, which may limit device performance and reliability, and as the stretching and contraction are repeated, reliability problems may occur, such as a decrease in elastic recovery force or fatigue failure due to accumulation of fatigue. Therefore, in order to use the film as a substrate for manufacturing high-performance devices and a reliable stretchable substrate, it is more preferable to insert the elastic auxiliary member 20. In addition, as will be described later, the Poisson's ratio may be controlled by adjusting the difference in elastic modulus between the fiber-reinforced plastic material and the elastic auxiliary member 20.

The composition of the fiber 12 may be any one or more selected from the group consisting of glass, silica, carbon, quartz, and aramid. Specifically, it may be glass or aramid. The fiber-reinforced plastic material of the composition has high tensile strength and stiffness, so that the film is less deformed during stretching and may impart structural stability to the film.

The plastic may be one or more selected from the group consisting of synthetic, synthetic rubber, natural resin, and natural rubber; which is any one of thermosetting, thermoplastic, photo polymerizing, and room temperature vulcanizing. The plastic may be, specifically, synthetic rubber, and more specifically, PDMS (polydimethylsiloxane) or Ecoflex. Since these plastics have high toughness and a wide elastic recovery area, the fiber-reinforced composite film including them may be used as a reliable stretchable substrate that may be easily recovered from physical stress factors such as repeated bending and stretching.

The elastic modulus of the fiber-reinforced plastic material may be at least 500 tiles of the elastic auxiliary member 20. When the space region 130 is filled with the elastic auxiliary member 20, the rotation of the island 120 causes the space region 130 aligned in the first axial direction (x-axis direction) to expand when the film is stretched, and at this time, elongation occurs in the elastic auxiliary member 20, and the elastic restoring force to be contracted acts in a direction that resists the stretching of the film. However, when having a difference in elastic modulus in the above range, the rotational force of the island 120 is superior to the elastic restoring force of the elastic auxiliary member 20, since the fiber-reinforced plastic material has a much higher elastic modulus than the elastic auxiliary member 20, which a negative Poisson's ratio value may be exhibited. For example, referring to FIG. 2, when the fiber-reinforced composite film 1 with omnidirectional stretchable according to an embodiment of the present invention is stretched in the first direction (x-axis direction), rotation of the island 120 causes the first space region 130 aligned in the first axial direction (x-axis direction) to expand. At this time, since the elastic restoring force acts on the elastic auxiliary member 20, stretching of the film in the second direction (y-axis direction) is hindered. However, due to the high elastic modulus of the fiber-reinforced part 10, the film continuously expands in the second direction (y-axis direction) and may exhibit a negative Poisson's ratio value. However, the Poisson's ratio may gradually increase as the difference in elastic modulus between the fiber-reinforced part 10 and the elastic auxiliary member 20 decreases. If the difference between the elastic modulus of the fiber reinforced part 10 and the elastic modulus of the elastic auxiliary member 20 is too small, the film may exhibit a positive Poisson's ratio value, although smaller than the original elastic modulus of the elastic auxiliary member 20.

The elastic auxiliary member 20 may be one or more selected from the group consisting of synthetic resin, synthetic rubber, natural resin, and natural rubber; which is any one of thermosetting, thermoplastic, photo polymerizing, and room temperature vulcanizing. Synthetic rubber may be at least one selected from the group consisting of butadiene-rubber, chloroprene-rubber, butyl rubber, ethylene-rubber, isoprene-rubber, urethane-rubber and silicone-rubber, and the silicone-based rubber may be polydimethylsiloxane (PDMS) or Ecoflex. Natural rubber may be latex. The synthetic resin may be one or more selected from the group consisting of polypropylene, polyethylene, polycarbonate, vinyl (polyvinylchloride), and ABS (acrylonitrile-butadiene-styrene). The elastic auxiliary member 20 may be, specifically, synthetic rubber, more specifically, silicone-based rubber, and more specifically, Ecoflex. The stretchable material may be a gel or hydrogel. The elastic auxiliary member 20 may be, specifically, synthetic rubber, and more specifically, PDMS or Ecoflex. Since the elastic auxiliary member 20 has a wide range of elastic recovery area, when the tensile force applied to the fiber-reinforced composite film including the same is removed, the film may be smoothly restored, and due to a low elastic modulus, when the fiber-reinforced composite film is stretched, the elastic restoring force that is induced in a direction perpendicular to the stretching direction and hinders the stretching may be minimized.

### Manufacturing Method of Fiber-Reinforced Composite Film

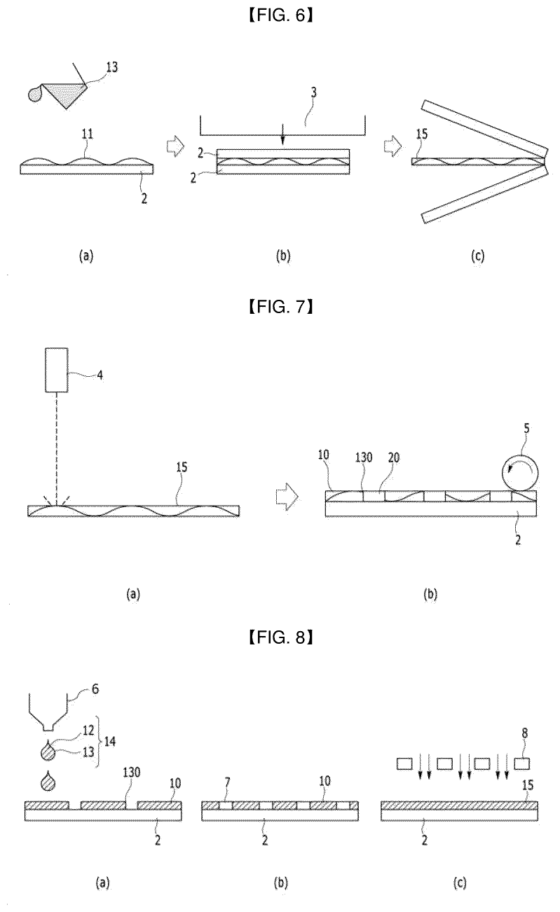

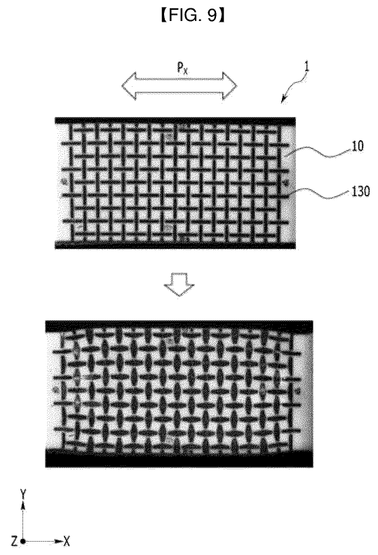

FIG. 5 is a flowchart showing a method of manufacturing a fiber-reinforced composite film 1 with omnidirectional stretchability according to an embodiment of the present invention and FIG. 6 is a schematic diagram showing a step of manufacturing a fiber-reinforced composite film 15 in a method for manufacturing a fiber-reinforced composite film 1 with omnidirectional stretchability according to an embodiment of the present invention and FIG. 7 is a schematic diagram showing of process of forming the space region 130 by cutting the fiber-reinforced composite film 15 with laser cutter 4 and then filling the elastic auxiliary member 20 in the space region 130 by the roll lamination method, in an embodiment of the present invention and FIG. 8 shows (a) ink-jet printing (b) molding (c) photolithography among various methods that can be used when forming a space region 130 in a fiber-reinforced composite film 15 in a method for manufacturing a fiber-reinforced composite film 1 with omnidirectional stretchability according to an embodiment of the present invention.

Hereinafter, a method for manufacturing a fiber-reinforced composite film 1 with omnidirectional stretchability according to an embodiment of the present invention will be described in detail with reference to FIGS. 5 to 8.

A method for manufacturing a fiber-reinforced composite film 1 with omnidirectional stretchability according to an embodiment of the present invention, may comprise: manufacturing a fiber-reinforced plastic film; and forming an auxetic structure 100 by forming a space region 130 on the film; and filling the space region 130 with an elastic auxiliary member 20.

The composition of the fiber 12 may be one or more selected from the group consisting of glass, silica, quartz, carbon and aramid.

The step of manufacturing a fiber-reinforced plastic film may be performed by one or more methods selected from the group consisting of hand layup, vacuum bag molding, infusion, vacuum infusion, ink-jet printing, resin transfer molding and screen printing, as long as it does not deviate from the manufacturing method of conventional fiber reinforced plastics (FRP), it is not limited thereto. Specifically, the step of preparing a fiber-reinforced plastic film; may be performed by a vacuum bag molding method.

The step of manufacturing a fiber-reinforced plastic film may comprises manufacturing a fiber-plastic matrix mixture 14 by compositing the fibers 12 and the plastic matrix material 13; forming the fiber-plastic matrix mixture 14 into a film form; and curing the mixture molded into the film form to manufacture a fiber-reinforced composite film 15.

The step of manufacturing a fiber-plastic matrix material mixture 14 by compositing the fiber 12 and the plastic matrix material 13; may be performed by a method of placing the fibers 12 on a support plate and pouring the plastic matrix material 13 before curing and impregnating, or it may be performed by putting the fibers 12 in the matrix and mixing them, but not limited thereto.

The fiber 12 may have one or more shapes selected from the group consisting of particles, yarns, strands, and fabrics. Specifically, It may be one or more types selected from the group consisting of cloth, nonwoven fabric, mesh, beads, powder, flake, uni-directional fiber, fiber mat, chopped fiber and milled fiber, but is not limited thereto.

The support plate may be flat or curved depending on the purpose, may be smooth or rough, may have a surface shape including a structure, and may be released or bonded to a film to be manufactured.

Molding the fiber-plastic matrix material mixture 14 into a film form; may comprise a step forming a surface suitable for the purpose by placing the fiber-plastic matrix material mixture 14 between support plates and then compressing it with a compressor 3. In this case, manufacturing the fiber-reinforced plastic film; manufacturing a fiber-reinforced composite film 15 by curing the mixture molded into a film form; thereafter, a step of detaching the manufactured fiber-reinforced composite film 15 from the support plate; may further comprise.

Forming a surface suitable for the purpose by placing the fiber-plastic matrix material mixture 14 between the support plates and then compressing it with the compressor 3; may be performed under vacuum condition, or at high temperature and pressure.

Detaching the manufactured fiber-reinforced composite film 15 from the support plate; may be performed by a physical or chemical method, and specifically, may be performed by a simple detachment, thermal detachment, or laser lift off method, but not limited thereto.

Manufacturing a fiber-reinforced composite film 15 by curing the mixture molded into a film form; may be performed by one or more methods selected from the group consisting of thermal curing, photo-polymerization, and room temperature vulcanization, but is not limited thereto. In addition, manufacturing the fiber-reinforced composite film 15 by curing the mixture molded into a film form; may comprise a pre-curing step of not completely curing.

Forming an auxetic structure 100 by forming a space region 130 on the film; may be performed by one or more methods selected from the group consisting of laser cutting, press punch, computer numerical control (CNC) machining, molding, printing, and photolithography, but is not limited thereto.

Filling the space region 130 with the elastic auxiliary member 20; may be performed by one or more methods selected from the group consisting of screen printing, ink-jet printing, bar coating, spin coating, impregnation, hand layup, autoclave and resin infusion, but is not limited thereto.

In the description of the manufacturing method of the fiber-reinforced composite film, among the contents of the type, characteristics, and effects of the materials used and formed structures, the contents overlapping with the contents already described in the description of the fiber-reinforced composite film are omitted.

### Stretchable Device

A stretchable device according to an embodiment of the present invention may comprise the above-described fiber-reinforced composite film or a fiber-reinforced composite film manufactured by the above-described manufacturing method. Since the above-mentioned fiber-reinforced composite film or the fiber-reinforced composite film manufactured by the above-described manufacturing method has stretchability in all directions, and the high stiffness of the fiber-reinforced plastic minimizes deformation applied to the island 120 during expansion and contraction, an electronic device sensitive to strain may be formed on the island 120. Therefore, the stretchable device of the present invention has an excellent effect of preventing performance degradation of electronic devices such as sensors, optoelectronic devices, thin film transistors, and displays.

Hereinafter, embodiments of the present invention will be described in detail so that those skilled in the art can easily implement the present invention. However, the present invention may be embodied in many different forms and is not limited to the embodiments described herein.

### Example 1

Eight sheets of E-glass fabric (glass fabric, Nittobo, Japan) with a thickness of 25 μm are impregnated with a pre-curing solution of PDMS (Sylgard184™, Dow Corning, USA), and then it was placed between release-treated glass support plates and vacuum pressed to remove air bubbles. Thereafter, the glass fiber-PDMS mixture was thermally cured at 120° C. for 30 minutes to obtain a fiber-reinforced composite film (elastic modulus: 6 GPa). The cured fiber-reinforced composite film was detached from the support plate and then cut with a laser cutter 4 to form a space region 130 to prepare a film. The space region 130 has a rectangular shape of 3.2 mm in the length direction and 0.4 mm in the width direction, and is designed to be rotated at an angle of 90 degrees and separated from each other by 0.4 mm along the x-axis and y-axis.

### Example 2

A sheet of aramid fabric (Kolon, Korea) with a thickness of 300 μm is impregnated with a solution of Ecoflex (Ecoflex™, Smooth-on, USA) before curing, put between release-treated glass support plates, and cured at 120° C., and 50 bar for 2 hours by hot press method to obtain a fiber-reinforced composite film (elastic modulus: 6.7 GPa). The cured fiber-reinforced composite film was detached from the support plate and then cut with a laser cutter 4 to form a space region 130 to manufacture a film. The space region 130 has a rectangular shape of 8 mm in the length direction and 1 mm in the width direction, and is designed to be rotated at an angle of 90 degrees and separated by 1 mm from each other along the x-axis and y-axis.

### Example 3

Eight sheets of E-glass fabric (glass fabric, Nittobo, Japan) with a thickness of 25 μm are impregnated with a pre-curing solution of PDMS (Sylgard184™, Dow Corning, USA), and then it was placed between release-treated glass support plates and vacuum pressed to remove air bubbles. Thereafter, the glass fiber-PDMS mixture was thermally cured at 120° C. for 30 minutes to obtain a fiber-reinforced composite film (elastic modulus: 6 GPa). After the cured fiber-reinforced composite film was detached from the support plate, it was cut with a laser cutter 4 to form a space region 130. The space region 130 has a rectangular shape of 3.2 mm in the length direction and 0.4 mm in the width direction, and is designed to be rotated at an angle of 90 degrees and separated by 0.4 mm from each other along the x-axis and y-axis. After coating Ecoflex (Ecoflex™, Smooth-on, USA) in the space region 130 using a bar coating method, a release-treated glass support plate was covered and cured at room temperature for 24 hours to manufacture a film (elastic modulus of the Ecoflex part: 30 kPa).

### Example 4

A sheet of aramid fabric (Kolon, Korea) with a thickness of 300 μm is impregnated with a solution of Ecoflex (Ecoflex™, Smooth-on, USA) before curing, put between release-treated glass support plates, and cured at 120° C., and 50 bar for 2 hours by hot press method to obtain a fiber-reinforced composite film (elastic modulus: 6.7 GPa). After the cured fiber-reinforced composite film was detached from the support plate, it was cut with a laser cutter 4 to form a space region 130. The space region 130 has a rectangular shape of 8 mm in the length direction and 1 mm in the width direction, and is designed to be rotated at an angle of 90 degrees and separated by 1 mm from each other along the x-axis and y-axis. Thereafter, an uncured Ecoflex (Ecoflex™, Smooth-on Company, USA) solution was formed in the space by roll-lamination using a release film. Then, after curing at 60 ºC, for 4 hours, the release film was removed to manufacture a film (elastic modulus of the Ecoflex part: 30 kPa).

### Comparative Example 1

An Ecoflex (Ecoflex™, Smooth-on Company, USA) solution was poured into a mold having a size of 10 cm×10 cm×0.5 mm and cured at room temperature for 24 hours to manufacture a film.

### Comparative Example 2

A film (elastic modulus: 1 MPa) was fabricated by a thermal curing method using PDMS (Sylgard184™, Dow Corning, USA) having a thickness of 200 μm, and was cut with a laser cutter 4 to form a space region 130. The space region 130 has a rectangular shape of 3.2 mm in the length direction and 0.4 mm in the width direction, and is designed to be rotated at an angle of 90 degrees and separated from each other by 0.4 mm along the x-axis and y-axis. After coating Ecoflex (Ecoflex™, Smooth-on, USA) in the space region 130 using a bar coating method, a release-treated glass support plate was covered and cured at room temperature for 24 hours to manufacture a film (elastic modulus of the Ecoflex part: 30 kPa).

### Comparative Example 3

A space region 130 was formed by cutting with a laser cutter 4 on one sheet of CPI film (Kolon, Korea) having a thickness of 80 μm (elastic modulus: 7 GPa). The space region 130 has a rectangular shape of 3.2 mm in the length direction and 0.4 mm in the width direction, and is designed to be rotated at an angle of 90 degrees and separated from each other by 0.4 mm along the x-axis and y-axis. After coating Ecoflex (Ecoflex™, Smooth-on, USA) in the space region 130 using a bar coating method, a release-treated glass support plate was covered and cured at room temperature for 24 hours to manufacture a film (elastic modulus of the Ecoflex part: 30 kPa).

The present invention is not limited to the embodiments, but can be manufactured in a variety of different forms, and those skilled in the art to which the present invention pertains will understand that the present invention can be implemented in other specific forms without changing the technical spirit or essential characteristics of the present invention. Therefore, the embodiments described above should be understood as illustrative in all respects and not limiting.

### Experimental Example 1

The film of Example 3 was stretched by applying tension (Pₓ) in the first axial direction (x-axis direction), and the structural changes were observed. Referring to FIG. 9, it may be confirmed that the film of Example 3 demonstrates omnidirectional stretch characteristics and there is no significant change in the structure of the island 120 where the electronic device is manufactured on the film, and it may be confirmed that the degradation of performance and reliability of the electronic device may be improved even if conventional high-performance electronic devices that are vulnerable to deformation are manufactured on the film.

### Experimental Example 2

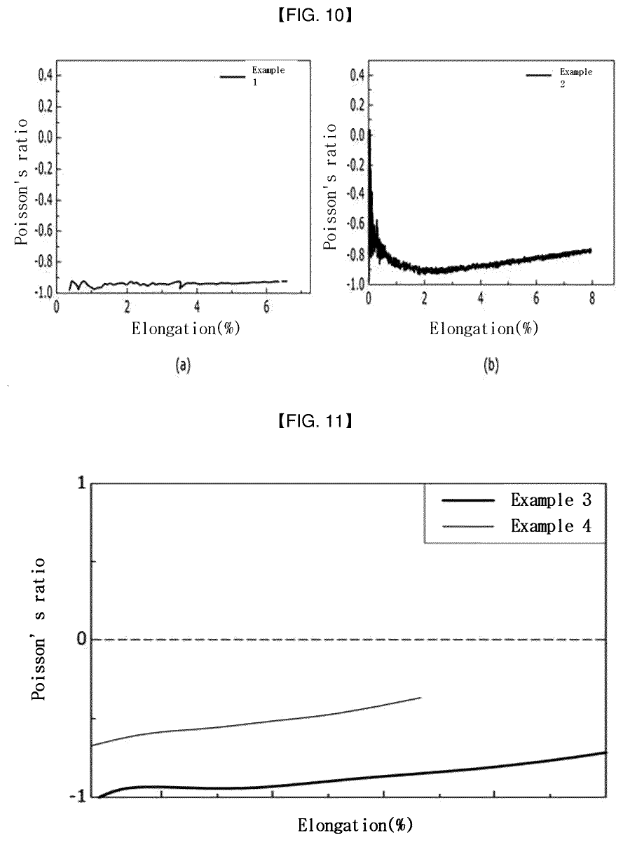

While stretching all the films of Examples and Comparative Examples by applying tension (Pₓ) in the first axial direction (x-axis direction), the Poisson's ratio according to the elongation was measured, and the results are shown in FIGS. 10 to 12. The Poisson's ratio was calculated from the strain in the horizontal and vertical axes obtained through digital image correlation (Aramis Professional program, Gom, Germany) from high-resolution images measured with a digital camera (800D, Canon, Japan). The standard markers for strain were marked with commercially available marker pens at both ends of the horizontal axis and the vertical axis across the center of the specimen and in order to obtain a uniform elongation rate, the specimen was stretched using a universal testing machine (AGS-X, Shimadzu, Japan).

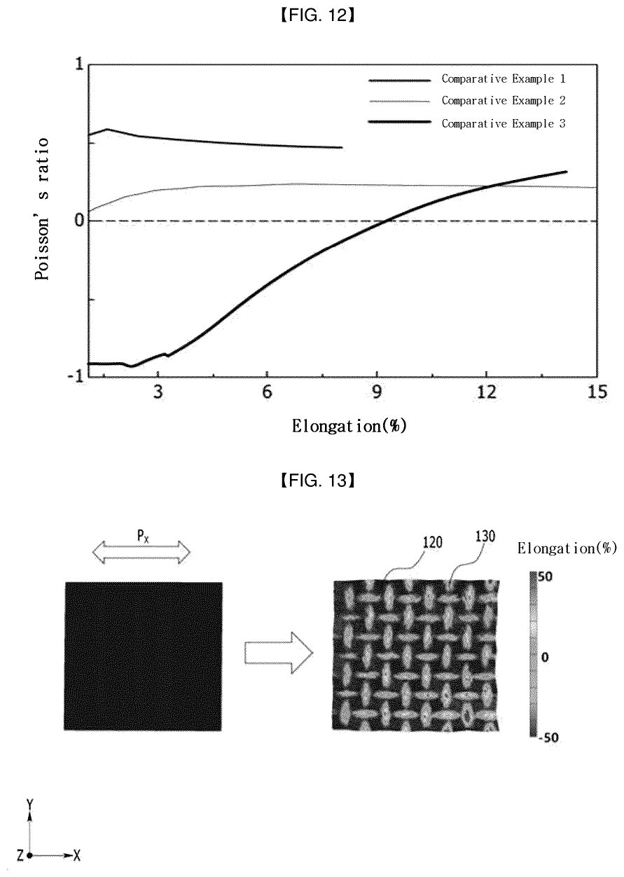

Referring to FIG. 10, in the case of a film manufactured using a fiber-reinforced composite and forming an auxetic structure 100 as in Examples 1 and 2, but without filling the space region 130 with the elastic auxiliary member 20, since it exhibits a Poisson's ratio close to −1, which is the ideal value of Poisson's ratio, it may be confirmed that it has excellent omnidirectional stretchability. And, referring to FIG. 11, in the case of the films of Examples 3 and 4 manufactured by filling the space region 130 with the elastic auxiliary member 20, since negative Poisson's ratio values were shown in all range of elongation rate, it was confirmed that they had excellent omnidirectional stretchability regardless of elongation, and it may be confirmed that the Poisson's ratio change tendency according to the elongation rate is similar to Examples 1 and 2 in which the elastic auxiliary member 20 is not filled in the space region 130. Referring to FIG. 12, since Comparative Example 1 is a single film and exhibits a Poisson's ratio close to 0.5 regardless of the elongation rate, it may be confirmed that the omnidirectional stretchability is poor. And, in the case of Comparative Example 2 without using a fiber-reinforced composite, since the difference in elastic modulus between PDMS and Ecoflex filled in the space region is low as 33 times, indicating positive Poisson's ratio value, it may be confirmed that the omnidirectional stretchability is poor. In the case of Comparative Example 3 without using a fiber-reinforced composite, the elastic modulus of the CPI film and the Ecoflex filled in the space zone showed a large difference similar to the difference in the elastic modulus of the film and the elastic auxiliary member in the case of Examples 3 and 4, indicating a negative Poisson's ratio value in the low elongation rate region, but from the elongation rate of 3%, the Poisson's ratio value begins to increase rapidly, and it may be confirmed that the Poisson's ratio value is positive in the high elongation rate region of 9% or more. This is due to characteristics of the CPI film having ductility, and shows a tendency to lose omnidirectional stretchability due to structural deformation of the island 120 in a high elongation region. Through this, even if the difference between the elastic modulus of the plastic part other than the space region 130 of the film and the elastic modulus of the elastic auxiliary member 20 formed in the space region 130 is large, it was found that only the examples manufactured using the fiber-reinforced composites had excellent omnidirectional stretchability in all elongation ranges.

### Experimental Example 3

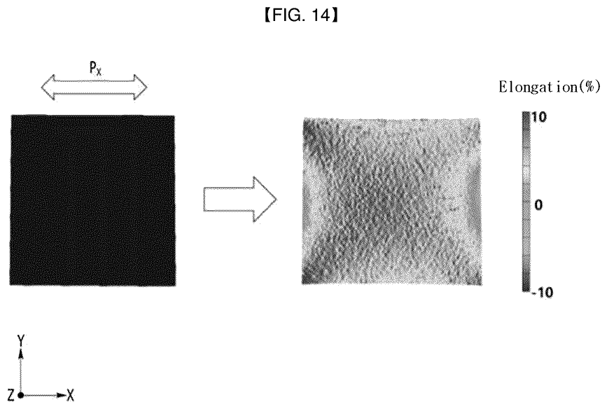

Stretching the films of Example 3 and Comparative Example 1 by applying tension (Pₓ) in the first axial direction (x-axis direction), and the change in elongation in the film was measured using the digital image correlation method in the same manner as in Experimental Example 2, and the results are shown in FIGS. 13 and 14, respectively. Referring to FIG. 13, in the case of Example 3, almost no deformation was applied to the island 120, and it was confirmed that the film was uniformly expanded even after stretching, so it was found to have excellent omnidirectional stretchability. However, referring to FIG. 14, in the case of Comparative Example 1, since it may be confirmed that the central portion of the film is contracted and concavely distorted due to the high Poisson's ratio, it may be confirmed that it is unsuitable for use as a substrate for a stretchable device because it has inferior omnidirectional stretchability.

### DESCRIPTION OF SYMBOLS

100: Auxetic structure
110: Connection portion
110A: The first connection portion
110B: The second connection portion
120: Island
120A: The first Island
120B: The second Island
121: Virtual rotation axis
121A: The first virtual rotation axis
121B: The second virtual rotation axis
130: Space region
131˜142: The shape of the space region 130
143˜145: The shape of space region 130 (non-orthogonal coordinate system)
10: Fiber-reinforced part
11: Fabric
12: Fiber
13: Plastic matrix material
14: Fiber-plastic matrix material mixture
15: Fiber-reinforced composite film
20: Elastic auxiliary member
1: Fiber-reinforced composite film with omnidirectional stretchability
2: Release treated support plate
3: Compressor
4: Laser cutter
5: Roller
6: Inkjet Printer
7: Mold
8: Photomask
S100: Flow chart of a method for manufacturing a fiber-reinforced composite film with omnidirectional stretchability
Pₓ: Tensile force applied in the x-axis direction

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A fiber-reinforced composite film with omnidirectional stretchability, on which an auxetic structure 100 is formed integrally with the film on a film, wherein
the auxetic structure 100 comprises
a plurality of space regions 130 in the form of single closed curves regularly arranged on the film;
an island 120 formed surrounded by the space region 130; and
a connection portion 110 formed at regular intervals by the space region 130 to connect adjacent islands 120;
wherein the film, island 120 and connection portion 110 are plastic materials reinforced with fibers,
wherein the space region 130 is an empty space or filled with the elastic auxiliary member 20.

2. The fiber-reinforced composite film of claim 1, wherein:
The composition of the fiber 12 is at least one selected from the group consisting of glass, silica, quartz, carbon and aramid.

3. The fiber-reinforced composite film of claim 1, wherein:
the plastic is one or more selected from the group consisting of synthetic resin, synthetic rubber, natural resin, and natural rubber; which is any one of thermosetting, thermoplastic, photo polymerizing, and room temperature vulcanizing.

4. The fiber-reinforced composite film of claim 1, wherein:
the elastic modulus of the fiber-reinforced plastic material is at least 500 times of the elastic modulus of the elastic auxiliary member 20.

5. The fiber-reinforced composite film of claim 1, wherein:
the elastic auxiliary member 20 is one or more selected from the group consisting of synthetic, synthetic rubber, natural resin, and natural rubber; which is any one of thermosetting, thermoplastic, photo polymerizing, and room temperature vulcanizing.

6. The fiber-reinforced composite film of claim 1, having
a negative Poisson's ratio value.

7. The fiber-reinforced composite film of claim 1, having a Poisson's ratio value which is lower than any of its component materials.

8. A method for manufacturing a fiber-reinforced composite film with omnidirectional stretchability, comprising:
manufacturing a fiber-reinforced plastic film; and
forming an auxetic structure 100 by forming a space region 130 on the film.

9. The method of claim 8, further comprising:
filling the space region 130 with an elastic auxiliary member 20.

10. The method of claim 8, wherein:
the composition of the fiber 12 is one or more selected from the group consisting of glass, silica, quartz, carbon and aramid.

11. The method of claim 8, wherein
the step of manufacturing a fiber-reinforced plastic film comprises
manufacturing a fiber-plastic matrix mixture 14 by compositing the fibers 12 and the plastic matrix material 13;
forming the fiber-plastic matrix mixture 14 into a film form; and
curing the mixture molded into the film form to manufacture a fiber-reinforced composite film 15.

12. The method of claim 11, wherein:
the fiber 12 is one or more forms selected from the group consisting of particles, yarns, single yarns and fabrics.

13. The method of claim 11, wherein:
the step of manufacturing a fiber-reinforced composite film 15 by curing the mixture molded into a film form
is performed by one or more methods selected from the group consisting of thermal curing, photo-curing, and room temperature vulcanization.

14. The method of claim 8, wherein:
The step of forming an auxetic structure 100 by forming a space region 130 on the film
is performed by one or more methods selected from the group consisting of laser cutting, press punch, CNC (computer numerical control) processing, molding, printing, and photolithography.

15. The method of claim 8, wherein:
the step of filling the space region 130 with the elastic auxiliary member 20
is performed by one or more methods selected from the group consisting of screen printing, ink-jet printing, bar coating, spin coating, impregnation, hand layup, autoclave and resin infusion.

16. A stretchable device comprising the fiber-reinforced composite film of claim 1.

17. A stretchable device comprising the fiber-reinforced composite film manufactured by the manufacturing method of claim 8
